(19) United States
(12) Patent Application Publication
(10) Pub. No.: US 2013/0231971 A1
(43) Pub. Date: Sep. 5, 2013

(54) LEGAL PROJECT MANAGEMENT SYSTEM AND METHOD

(71) Applicants: JUDY BISHOP, Memphis, TN (US); Mike Burks, Alpharetta, GA (US); John Christenson, Cordova, TN (US); Paul Davis, Springhill, FL (US); Felicia Morris, Madison, MS (US); William Painter, Jackson, MS (US); Jennifer Reese, Millington, TN (US); David Rueff, Madison, MS (US); Meredith Williams, Winston-Salem, NC (US); Conda Winchester, Arlington, TN (US)

(72) Inventors: JUDY BISHOP, Memphis, TN (US); Mike Burks, Alpharetta, GA (US); John Christenson, Cordova, TN (US); Paul Davis, Springhill, FL (US); Felicia Morris, Madison, MS (US); William Painter, Jackson, MS (US); Jennifer Reese, Millington, TN (US); David Rueff, Madison, MS (US); Meredith Williams, Winston-Salem, NC (US); Conda Winchester, Arlington, TN (US)

(21) Appl. No.: 13/593,244

(22) Filed: Aug. 23, 2012

Related U.S. Application Data
(60) Provisional application No. 61/526,337, filed on Aug. 23, 2011.

(51) Int. Cl. G06Q 10/06

(52) U.S. Cl. CPC G06Q 10/063114
USPC 705/7.15

(57) ABSTRACT

A computer-implemented system for developing, tracking and managing legal (and other professional services) projects or matters through the Legal Project Management (LPM) process. The LPM process divides the management of a legal matter or project into three phases: Project Development; Project Execution; and Project Closure. The Project Development Phase includes conflict screening, fee arrangements, identification of the nature and scope of the matter, the goals of the stakeholders, the tasks associated with the matter, and development of a schedule, budget, and a communications plan. The Project Execution Phase involves monitoring the progress of the matter, tracking the actual time and cost to budget, identifying risks and changes to the scope of the matter as they develop, and communicating among team members. The Project Closure Phase includes file closure procedures, and team and client meetings to identify lessons learned in the engagement for future improvement.

This application claims benefit of and priority to U.S. Provisional Application No. 61/526,337, filed Aug. 23, 2011, and is entitled to that filing date for priority. The specification, figures, attachments and complete disclosure of U.S. Provisional Application No. 61/526,337 are incorporated herein by specific reference for all purposes.

### FIELD OF INVENTION

This invention relates to a system and related methods for developing, tracking and managing legal and other forms of professional service projects.

### BACKGROUND OF THE INVENTION

Law firms are under pressure to reduce rates and costs for legal services provided to a variety of clients. These pressures force many law firms to compete aggressively on price, and to focus on remaining profitable in the changing marketplace. This requires an emphasis on efficiency and management: The law firm needs to ensure that legal matters are completed on time, within budgetary constraints, and utilize assigned resources effectively and efficiently. These concerns are of particular importance when using alternative fee arrangements, where the law firm bears the risk of inefficiency and increased costs due to the expansion of project scope.

### SUMMARY OF INVENTION

In various embodiments, the present invention comprises a computer-implemented system for developing, tracking and managing legal (and other professional services) projects or matters. In one embodiment, the present invention divides the management of a legal matter or project into three phases: Project Development; Project Execution; and Project Closure. The Project Development Phase includes initial conflict screening; determination and approval of fee arrangements; identification of the nature and scope of the matter, the goals of the stakeholders, the tasks associated with the matter; and development of a schedule, budget, and a communications plan. The Project Execution Phase involves monitoring the progress of the matter, tracking the actual time/cost to budget, identifying risks and changes to the scope of the matter as they develop, and communicating among the LPM Team members and with the client and other third party stakeholders as the matter progresses. The Project Closure Phase includes the Firm's existing file closure procedures, but also incorporates team and client meetings to identify lessons learned in the engagement for future improvement. The final step in the closure process includes updating existing resources such as templates, forms, and procedures to ensure that the next engagement or matter for the client will be improved. These phases are discussed in further detail below.

In the Project Development Phase, the user identifies the scope of the matter, and develops the task lists, schedule, budget, and communications arrangements for the matter. In general, the phase starts with conflict screening, and a determination of the fee arrangement. The original attorney and the client then hold an initial client meeting to begin to discuss and craft the scope of the engagement. This meeting typically should be conducted with a client decision-maker or stakeholder (i.e., someone who has a “stake” in the positive outcome of the matter). The client and originating attorney should identify all potential stakeholders within and outside the law firm who will participate in the engagement. Additionally, the originating attorney should gather the background facts, obtain any supporting documents, and develop a summary statement of the client's expectations with regard to the engagement (i.e., the scope of the matter). A variety of forms for collecting this information may be provided.

After the initial client meeting, the originating attorney should meet with the proposed team members, and further develop the scope in order. This should include identifying assumptions, risks, and what is out of scope for the engagement. This information is used to identify the tasks necessary to manage the engagement. Additionally, the originating attorney should identify the law firm personnel who will participate in the matter, third party resources, and any additional firm facilities that will be necessary for the engagement (e.g., workspace, software, and the like). This information can be captured in a Statement of Work form.

One important component of the process is the development of the task list. The task list should elaborate all of the assignments that will be necessary for the entire engagement. Practice groups may develop form task lists and templates. These templates can then be used as a starting point for the development of a task list for a specific matter. The template will be available through the system and can be altered based upon the scope of the matter.

Once the task list is developed, the system is used to develop a schedule to assign distinct tasks to individual team members, set deadlines for completion of tasks, and identify external deadlines for court filings or contractual obligations. The tasks are also used to create a projected budget which, in one embodiment, comprises the rate for the assigned team member, the estimated time for completion of the task, and any risk variables that may impact the estimated time. The system also provides the ability to develop a communication plan for the engagement in order to encourage regular communications among team members to promote efficiency and with the client to confirm expectations and report results. This plan will also identify a procedure or a change control process for responding to changes in the original scope of the engagement.

In the Project Execution Phase, the user controls the scope of the engagement, confirms that tasks are on schedule, ensures that team members are operating consistently within the approved budget, and implements regular communications with the team and the client. In the embodiment shown, the processes implemented in the Project Execution Phase may comprise the following: Monitoring and Controlling Tasks, Schedules, Budgets and Resources; Team Communication (including implementation of corrective actions); Status Reports to the Client; and Change Control.

The system and forms aids in the oversight of the critical components of the engagement. The schedule form will provide team members with the ability to update statuses related to their assignments and will alert the responsible attorney to pending deadlines. The budget form will provide the responsible attorney with a comparison of actual to projected budget in order to identify tasks or team members at risk of exceeding budget. Communication tools can also be implemented, such as blogs, client extranets and scheduled reporting.

In practice, the initial scope will change throughout the life of the engagement due to new information, the tactics of opposing counsel, or other factors beyond the client's control. It is important for the user during the Project Execution Phase to closely monitor performance and to regularly communicate with team members and the client to identify these potential changes. Once identified, the change control process should be implemented to identify the impacts of the change on the original scope, schedule and budget. Once clearly identified, approvals should be obtained from the client and recorded in the change control log in the system.

In the Project Closure Phase, the user not only formally closes the file with the law firm's systems, but also capitalizes on the team's experience in managing the engagement. The processes implemented in the Project Closure Phase may comprise the following: Complete the Matter; Perform Final Matter Closure; Perform Formal File Closure within the law firm's systems. These may further comprise a client meeting to address lessons learned, the client's evaluation of the firm's work, a team meeting to address lessons learned, and updating firm resources such as forms and templates.

The system thus provides a formalized mechanism for capturing improvements to firm resources. It incorporates the creation of a lessons-learned log, which is made available to all team members in order to record recommended modifications to form documents, ideas for improving on procedures, updates to checklists and templates and client-requested changes for future matters.

Once a matter is completed, the law firm team may meet with the client to review the lessons-learned log in order to confirm the recommended changes. This should be followed up with a client evaluation which captures the client's impressions of the team's performance. Finally, the team should review the evaluation as a group and identify those team members who will be responsible for implementing the changes identified in the lessons learned log.

### DESCRIPTION OF THE DRAWINGS

FIG. 1 shows a view of a system in accordance with an embodiment of the present invention.

FIG. 2 shows another view of a system in accordance with an embodiment of the present invention.

FIG. 3 shows a view of a Description of Engagement page from an LPM system interface in accordance with an embodiment of the present invention.

FIG. 4 shows a view of a Case Background page from an LPM system interface in accordance with an embodiment of the present invention.

FIG. 5 shows a view of a Shareholders/Contact page from an LPM system interface in accordance with an embodiment of the present invention.

FIG. 6 shows a view of a Statement of Work page from an LPM system interface in accordance with an embodiment of the present invention.

FIG. 7 shows a view of a Communications Plan page from an LPM system interface in accordance with an embodiment of the present invention.

FIG. 8 shows a view of a Case Notes page from an LPM system interface in accordance with an embodiment of the present invention.

FIG. 9 shows a view of a Lessons Learned Log page from an LPM system interface in accordance with an embodiment of the present invention.

FIG. 10 shows a view of an Assignment of Tasks page from an LPM system interface in accordance with an embodiment of the present invention.

FIG. 11 shows a diagram of a three-level phase/task code system.

FIG. 12 shows a view of a Budget page from an LPM system interface in accordance with an embodiment of the present invention.

FIG. 13 shows a view of a Team Calendar page from an LPM system interface in accordance with an embodiment of the present invention.

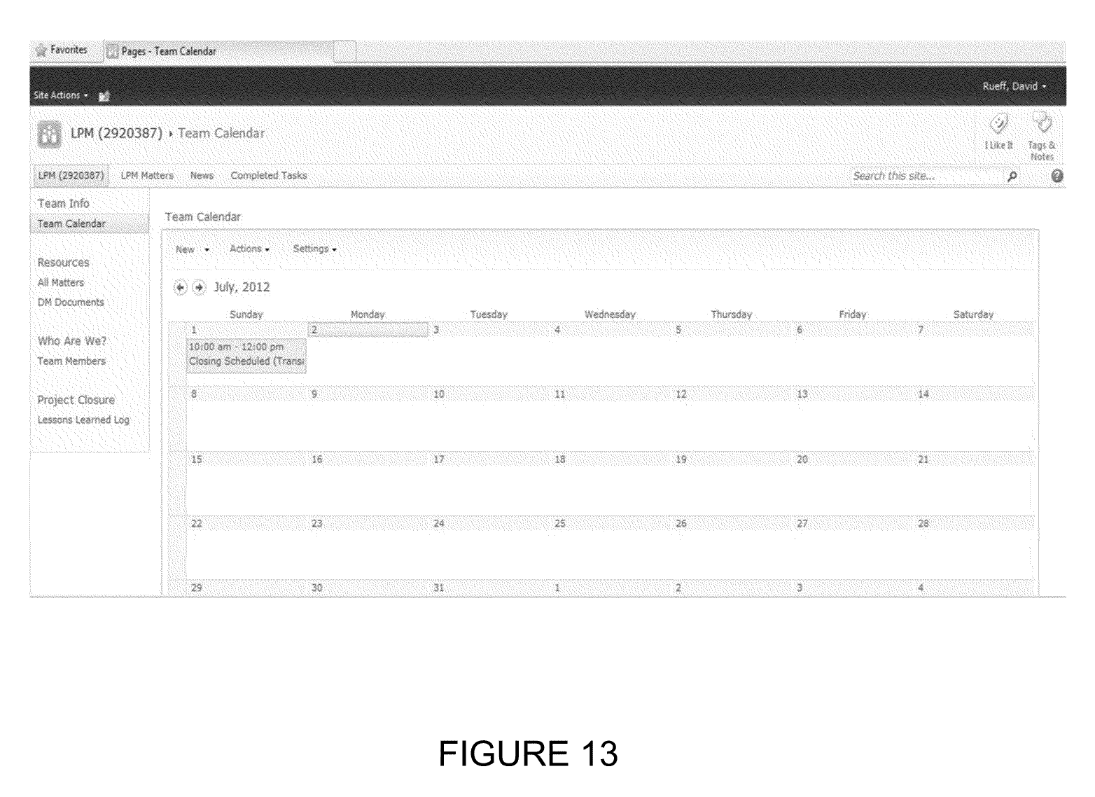

FIG. 14 shows a view of a Reports page from an LPM system interface in accordance with an embodiment of the present invention.

FIG. 15 shows a view of an 80% Over Budget page from an LPM system interface in accordance with an embodiment of the present invention.

### DETAILED DESCRIPTION OF EXEMPLARY EMBODIMENTS

In various exemplary embodiments, the present invention comprises a system and related methods for implementing Legal Project Management (“LPM”). LPM is a skill set and discipline that uses planning, organization, and communications to insure that a client matter for a law firm (the “Firm”) adheres to a set of defined objectives for scope, cost, and time (sometimes called the “triple constraint”). Typical project management design includes a large number of process, which are used to manage the life cycle of a project, confirm compliance with previously established goals, and provide for continuous improvement. While the embodiments described herein are set forth in the context of a law firm where the users are attorneys or staff members, the system and methods of the present invention may be used by any organization or firm providing professional or consulting or similar services.

In general, the LPM process defines processes most relevant to the administration of legal matters and to incorporate those processes into effective matter management. It can be used in conjunction with alternative fee arrangements (“AFAs”), and also can be used to manage any complex matter, even when the fee is based on hourly rates. The LPM system is used to clearly identify the scope of a client matter, define the tasks to accomplish the objectives, manage the tasks to a timetable and budget, and communicate progress and changes with the client throughout the life cycle of the matter.

The LPM system is very flexible; it is not a “one size fits all” proposition. In one embodiment, there is a low, medium, and high level of LPM, depending on the information available, the nature of the matter, and the timeframe involved. Often at an early stage of a potential matter, a user will not have sufficient information or time to be rigorous about the processes. As information becomes available and time permits, however, the user can bring the LPM system into play. For example, if the user is responding to a Request for Proposal (“RFP”) for a fixed fee engagement, he or she may not have enough information to develop a complete task list and budget. The user can still use the LPM system based on experience in similar matters, other information, and time available to develop and present the potential AFA to the user's Firm for approval in accordance with the Firm's AFA program, if any. Certain aspects may, in fact, be critical to accepting such an engagement (e.g., what tasks are excluded from the fee quote) and the LPM system can help identify those critical aspects and resolve them if possible.

The benefits of the LPM system include well-defined client expectations, increased client value, fewer (and lower) write-offs and discounted fees, minimized cost, and greater efficiency. Most importantly, the LPM system can provide greater predictability for both a Firm and clients with regard to the ultimate fee and resolution of the matter. The LPM system also can help create templates for budgets, task lists and procedures, and form documents for future matters and help ensure consistency of work product across a Firm.

In one embodiment, the LPM system can be implemented in association with a Firm's internal Legal Project Management Office (“LPMO”), or the equivalent, to assist the professionals and staff members within that Firm in implementing, monitoring and managing the LPM system. An LPMO is primarily responsible for defining processes and providing oversight and assistance for the implementation of the LPM system. The existence of the LPMO and the availability of staff will enhance repetition and continuous improvement in the execution of project management principles.

In one embodiment, an LPMO comprises full-time project managers and support staff to help users implement the LPM system, manage its operation, monitor progress, and offer solutions and resources as requested. Every matter using the LPM system should be registered with the LPMO office, and a member of the LPMO may be consulted at the initiation of each LPM system matter to help the user determine information required and resources needed and to set up the internal tools to manage the project. Project Managers with the LPMO should be available to assist the responsible attorney throughout the life cycle of the matter and will help monitor adherence to the LPM process.

The LPMO may work regularly with a Firm's Project Management, Knowledge Management, and Budgeting Offices, or their equivalents, to develop consistency and to identify improvements to the LPM processes and supporting tools. The following is a summary of the services that may be offered by an LPMO:
PM counseling for transactional practice groups
Development of task lists, budgets, and checklists for best practices/implementation of the LPM system
Support for the evaluation of alternative fee proposals
Support for the integration of other firm tools, such as extranets, deal rooms and document assembly applications
Evaluation of case history and integration of lessons learned into future projects
Development of task lists, budgets, and checklists for best practices/implementation of the LPM system
Develop procedures for data handling and litigation support
Assist with the preparation of responses to RFPs
Case management (e.g., CaseMap, TimeMap, CaseNotebook)
Deposition transcripts (e.g., TextMap, LiveNote, CaseNotebook)
Trial support/presentation graphics, video, audio and exhibits (e.g., TrialDirector)
Support for management of discovery and case data at trial
Coordinate web-based collaboration resources for litigation (e.g., extranets)
Improve management and oversight of E-Discovery work
Provide support for document reviews and ESI-related projects

In another exemplary embodiment, the LPM system provides a simple budgeting tool for the development of a projected budget, and for tracking that projected budget against actual billings on the matter. The budgeting tool allows the input of an estimated time to complete the task which is multiplied against the rate for the time keeper. By assigning this information for all the tasks associated with the matter, a projected budget can be developed in the Budget tab of the LPM system. The ability to model actual costs of individual time keepers in order to identify a projected return also is available through a Budget Manager software package.

The Budget Manager is used to develop AFAs for RFPs or other proposed matters, and for any proposed fee arrangement which is not an hourly rate matter at standard or approved rates. The Budget Manager interfaces with a Firm's accounting systems by pulling actual time, costs and billing amounts directly into the program in order to track results. Budget Manager also provides useful, customizable templates with which to build a budget and help set a price, and it can produce a wide variety of budget views in multiple formats. For alternative fee arrangements, Budget Manager will allow the user to look at the budget at the phase/task code level, or at a more detailed level by specific timekeeper for each task code. This facilitates both pricing an AFA prospect and managing the AFA engagement as part of the LPM system, which supports this process both in development and execution of the matter. In order to develop a reliable estimate of work to be done on any engagement, especially important in an AFA engagement, users must think through the scope of work, the tasks to be performed, the details of staffing the tasks, the time frame for completion of the tasks and, based on these inputs, the overall budget for the engagement. Additionally, a communication plan scaled to fit the matter must be developed for both the team of users using the LPM system for the matter (the “LPM Team”), to review the scope of the matter as it develops and make changes as required, and the client, to periodically discuss status and changes which may require a change to the budget, timetable, or resources employed. These are the essential elements of the “Project Development Phase” of the LPM system, and they are essential to obtaining approval of an AFA engagement. Once these elements are developed, the Budget Manager may be used to develop an approved budget for the AFA matter.

The LPM system is also used in the execution and closure phases of a matter. The “Project Execution Phase” of the engagement also employs processes to determine if risk issues, changes in assumptions, or other events require a scope change so that the client can be informed and adjustments can be made to the budget and fee arrangement in the nature of a “change order.” During this phase, the budget can be managed in the specialized views of Budget Manager and displayed within the Budget tab of the LPM system to provide one central location for all of the information related to the matter. At the end of an engagement or the “Project Closure Phase,” the Firm can review the results to assess the extent to which assumptions were complete and accurate and to incorporate lessons learned into handling future matters.

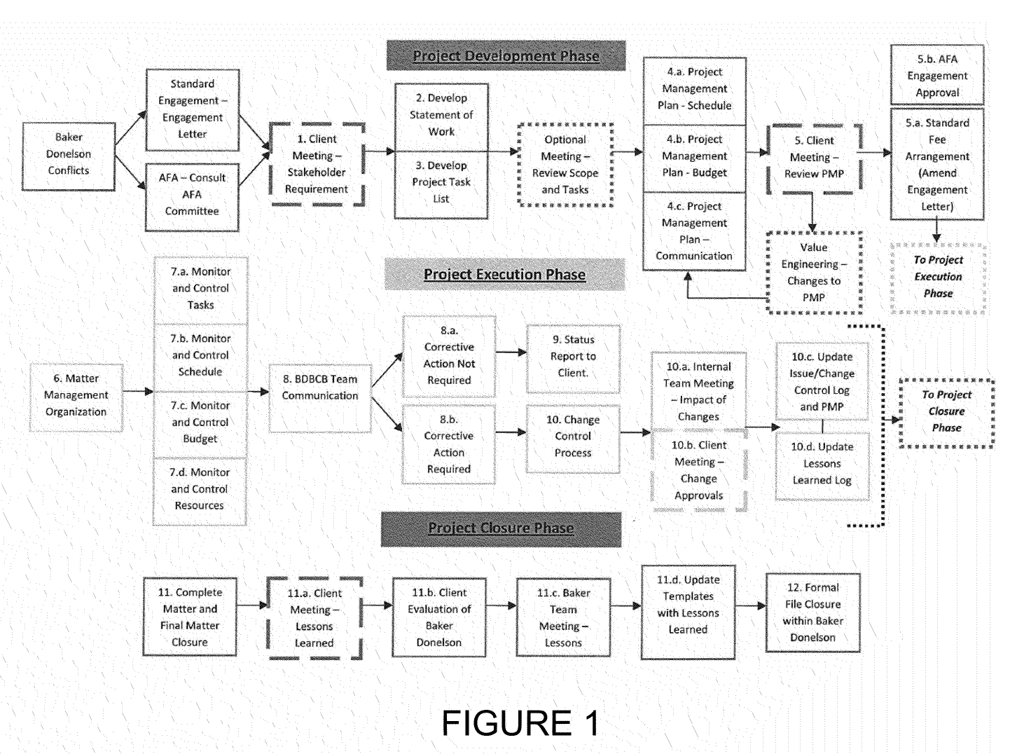

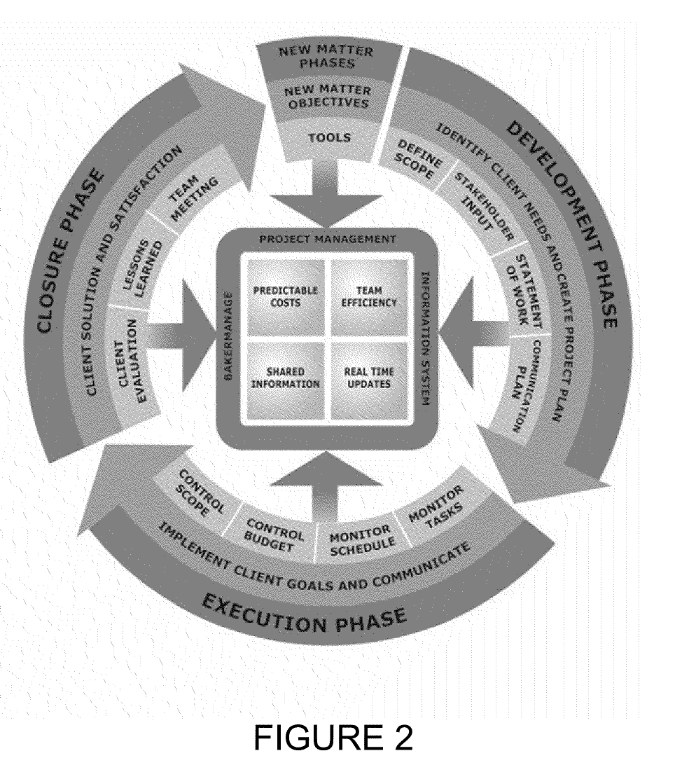

Accordingly, in one exemplary embodiment, as seen in FIGS. 1 and 2, the present system divides the management of a legal matter or project into three phases: Project Development; Project Execution; and Project Closure. The Project Development Phase includes initial conflict screening; determination and approval of fee arrangements; identification of the nature and scope of the matter, the goals of the stakeholders, the tasks associated with the matter; and development of a schedule, budget, and a communications plan. The Project Execution Phase involves monitoring the progress of the matter, tracking the actual time/cost to budget, identifying risks and changes to the scope of the matter as they develop, and communicating among the LPM Team members and with the client and other third party stakeholders as the matter progresses. The Project Closure Phase includes the Firm's existing file closure procedures, but also incorporates team and client meetings to identify lessons learned in the engagement for future improvement. The final step in the closure process includes updating existing resources such as templates, forms, and procedures to ensure that the next engagement or matter for the client will be improved.

In one exemplary embodiment, the LPM system is accessed through a webpage on the Internet or other network. This webpage may include a checklist for opening a new matter and working within the LPM process. The checklist provides guidance on the process of gathering information from the initial client meeting for conflicts, stakeholder contacts and requirements, setting the file up in a client management system, and undertaking the first steps of the Project Development Phase.

In this embodiment, the starting point for any engagement may be the conflict screening process. Once conflicts have been cleared, the next steps will vary depending on whether the client has already selected the Firm for an hourly engagement or whether the Firm is responding to a Request for Proposal (RFP) or developing an Alternative Fee Arrangement (AFA) proposal. For hourly engagements, the LPM system will generally begin with the opening of a file and execution of an engagement letter. If the engagement potentially includes an AFA, the originating attorney should immediately consult with the AFA Manager, or the equivalent authority, to identify the pricing strategy, confirm the information to be collected from the client (including the information required as part of the Project Development Phase), determine what information the Firm may already possess that would be helpful in developing the matter schedule and budget, and identify any risks inherent in the anticipated fee structure. The proposed fee arrangement between the Firm and the client will likely be discussed in the initial client meetings, but no AFA can be addressed with sufficient detail until the Project Plan is developed and approved by the client. The Project Plan will enable both the client and the LPM Team to estimate the fee with more accuracy and reliability, including the tasks and subtasks required to manage the matter in the Project Execution Phase.

If the Firm will be compensated under a standard fee arrangement (e.g., hourly), the client attorney should prepare and provide the designated client representative with an engagement letter or addendum to a previously executed engagement letter, which references the documents previously prepared in the Project Development Phase (e.g., Stakeholders/Contacts, Statement of Work, Task List, and Project Plan) to confirm the client's agreement with the scope, rates, and Firm personnel who will participate in the matter. If the Firm will be compensated under an alternative fee arrangement, the originating attorney should have consulted with the AFA Manager, or equivalent, before conducting the initial client meeting to identify the pricing strategy, confirm the information that should be collected from the client, and identify any risks inherent in the anticipated fee structure. This information and any other requirements of the AFA Manager should be incorporated into the development of the Statement of Work, Task List, and the Project Plan. Before entering the Project Execution Phase, the LPM Team should have a follow-up meeting with the AFA Manager for approval of the fee arrangement.

In developing the Project Plan, an important step is the initial client meeting. The goal of the initial client meeting is to develop a high-level overview of the engagement that each LPM Team member can review and to identify who (e.g., within the client organization, outside the client organization, and within the Firm) has authority to direct certain decisions and aspects of the matter. These individuals are commonly referred to as “stakeholders,” because they have a vested interest or stake in the positive outcome of the matter.

The initial client meeting should be in person or by videoconference, if practicable. If the size of the matter or location of the stakeholders does not justify an in-person meeting or videoconference, the necessary information can be collected by conference call or by supplying the stakeholders with the template discussed below to fill out on their own.

The first priority for the initial client meeting should be to define the scope of the engagement and identify the client's expectations, goals, and requirements. This should be a high-level description, but sufficiently detailed to ensure clear understanding of the scope. It is also important to detail who is speaking for the client in setting these expectations, goals, and requirements.

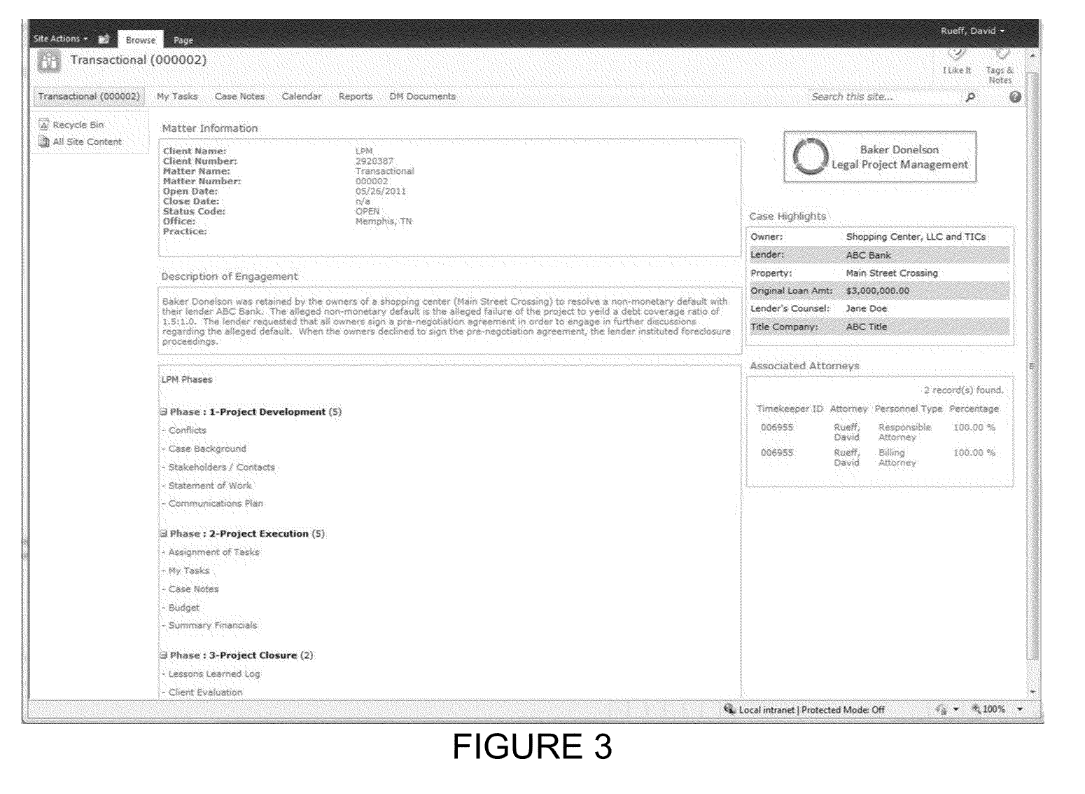

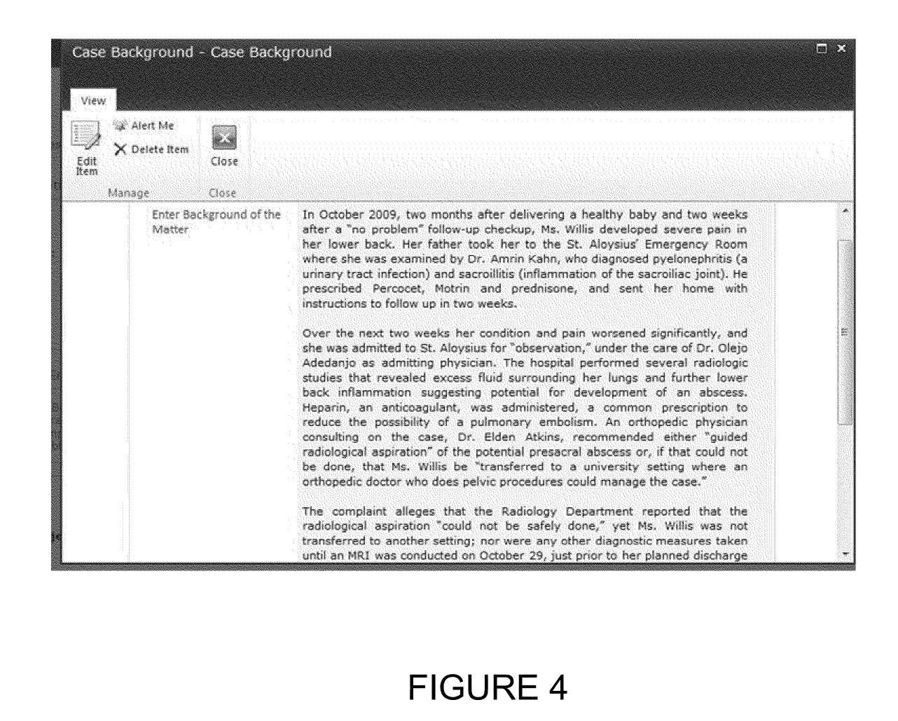

The LPM webpage interface provides a tool for this purpose, the Description of Engagement and Case Background, as seen FIGS. 3 and 4. The Matter Description form, which includes the Description of Engagement and Case Background, identifies the specific information which should be collected from the client:

a. Client/Matter Information. At the time of creation of the Matter Description and related background information, a Client/Matter number (or other client or matter identifier) may not be available. This information will be used to correlate the information back to a Client/Matter number once it is established.

b. Matter Source and Related Attorney Information. This information relates the matter to the originating Source, Requesting Attorney, Practice Group and Office.

c. Scope of the Engagement and Client Requirements. An authorized client representative should be identified and should provide a high-level description of the matter and the scope of the engagement. This should include a description of the client's expectations, goals and requirements.

d. Case Background. Obtain a statement of the factual background of the case, including any preliminary documents or industry specific terminology.

e. Conflicts Information. Confirm whether a conflicts check has been performed or initiated. Identify all adverse parties and any potential ethical walls.

f. Matter Plan and Related Billing Information. Select the matter plan (if using an existing template). Confirm whether there are any client billing guidelines. Confirm if the matter is customary hourly billed at standard rates (otherwise, this would indicate a special rate or some type of AFA).

The second priority for the initial client meeting is to identify stakeholders and their expectations, goals, and decision-making authority for the following areas of responsibility: scope (objectives, requirements or goals), schedule, budget, staffing, communications (reports), change control (approved changes or variances in scope, budget, or schedule), and acceptance of the closed matter. To achieve this objective, the steps are as follows:

First, identify client representatives (client stakeholders). Provide the role of each individual listed so that there is no confusion concerning responsibilities and the skills that each individual brings to the matter.

Second, identify the Firm representatives (internal stakeholders). Provide the role of each individual listed so that there is no confusion concerning responsibilities and the skills that each individual brings to the matter. These internal stakeholders should include:
Project Sponsor. The Firm attorney who is the client attorney or originating attorney.
Project Manager. The Firm attorney who will be responsible for the LPM process. While there may be more than one responsible attorney, only one responsible attorney should be identified as the Project Manager (hereafter, reference to the “responsible attorney” shall mean the responsible attorney who has the project management responsibilities).

Third, identify any third parties who will participate in the matter, such as co-counsel, experts, appraisers, and the like (external stakeholders). These are individuals outside the client organization who will have an impact on the matter. Identify the role and expertise of the individuals listed and their responsibilities.

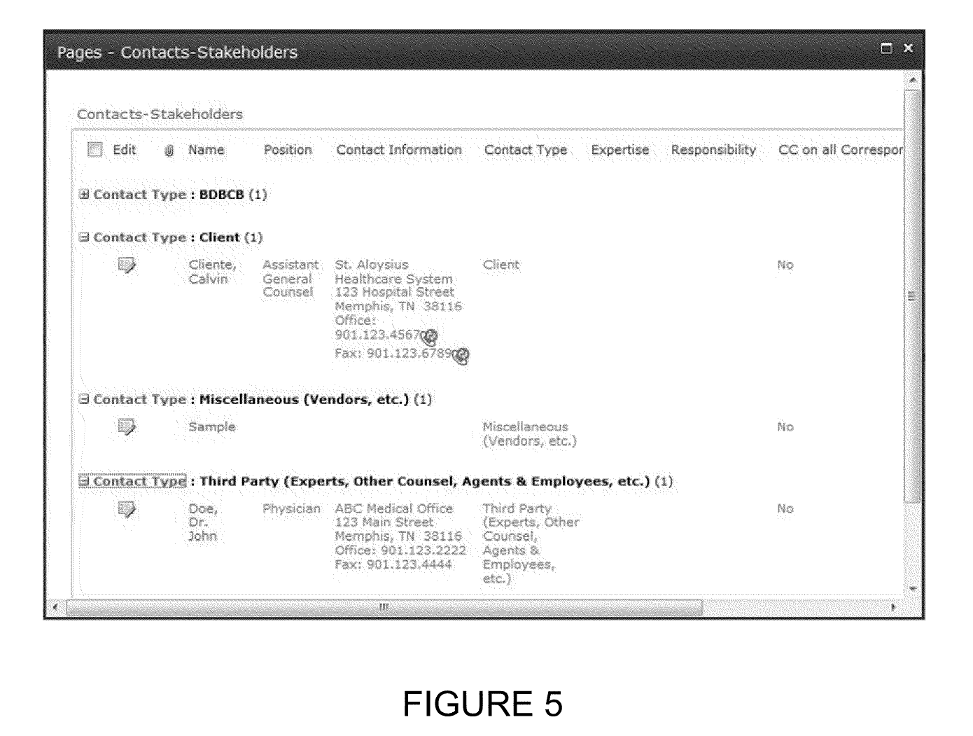

The following stakeholder information should be collected at this stage: position; contact information; contact type (e.g., Client/Firm/Miscellaneous/Third Party); expertise; responsibility; CC on all correspondence; project role/authority. The LPM webpage interface provides a tool for this purpose, the Stakeholder/Contacts tab as shown in FIG. 5. This information can either be manually entered on the page, as with an Excel spreadsheet, or, if the contact information has already been entered in a contact database, the stakeholders can be selected out of that contact database and pulled into the tab. If the contact database will be used to populate stakeholder information, the contact information in the database should be updated to include project role and expectations/goals/requirements for the matter. In one embodiment, all contacts are maintained at the client level but can be added/removed at either the client level or the matter level. This only requires entry and edits one time which then apply to all matters associated with the contact. The Stakeholder/Contacts can be accessed by selecting the tab as shown.

After the initial client meeting and completion of Stakeholder/Contacts, the LPM Team generates the Statement of Work. The Statement of Work provides a detailed description of the matter and formally defines what is within and outside of the scope of the matter. It documents the initial high-level requirements and any measurable objectives. It should also include the assumptions (factors known to be true that must be validated throughout the project life cycle), constraints (factors that limit the options), and exclusions from the services to be provided. The following is a summary of the information to be included in the Statement of Work:

a. Scope. Identify the client business need that supports the matter. Describe the expected deliverable or service objective. This is a high level description of the objectives with sufficient detail so that the client and the LPM Team are aware of the matter objectives, deliverables, and requirements. The user should use language that is concise and explanatory.

b. Assumptions. Identify any factual assumptions being made with regard to scope. If untrue or inaccurate, these could broaden the scope of services, timing resources and/or budget.

c. Risks. Provide a general description of any risks that may be encountered during the matter which could broaden the scope of services beyond the initial scope (time, resources and budget). Identify how these risks can be minimized. If possible, provide a general description of any risk mitigation and action steps that can be used to minimize the risk.

d. Out of Scope. Provide a general description of anything that would be considered outside the stated objectives, deliverables, and requirements.

e. Budgeted Time. If a fixed fee or other alternative fee arrangement, this should be clearly stated and the details of the arrangement should be provided to the team including any success fees. If the client has been provided a proposed budget by phase of the matter, it should be clearly stated.

f. Budgeted Expenses. Identify if there are limits on expenses (e.g., photocopying, courier charges, telephone and fax charges, research, and the like), on overtime or the number of hours billed in a day, and if there are prohibitions on litigation support expenses. Identify facilities resources which might be considered an expense or billable to the client such as materials, legal research, workspace requirements and matter management tools.

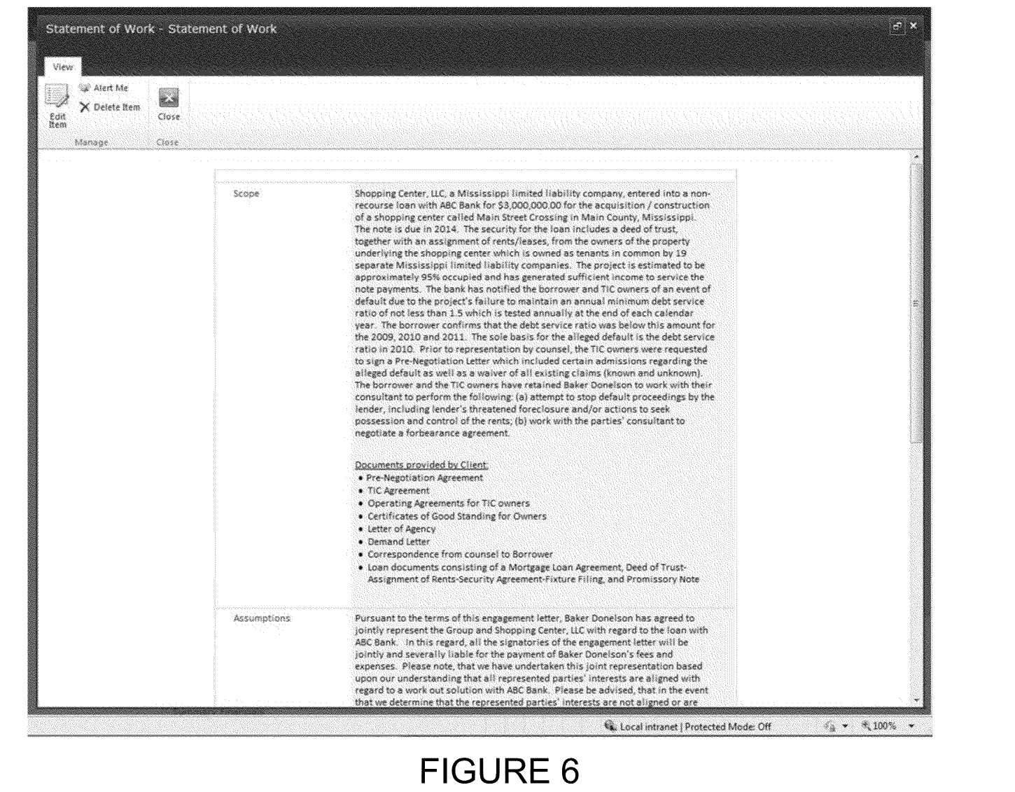

The LPM webpage interface provides a form for the entry of this information in the Statement of Work tab which can be selected as shown in FIG. 6.

The next step is the creation of a Communications Plan. Communication is essential to successful matter management. Simply stated, planning communications involves how much of which information is sent to whom, in what format, and how often. The object is to create a bridge among the client, the LPM Team, and external stakeholders. Communication is an iterative process that is modified and refined as the matter progresses. The Communications Plan should be developed to address both internal communications among LPM Team members and administrative personnel, and external communications with the client and external stakeholders identified in the Stakeholders/Contacts.

For internal communications, the Communications Plan should address communication of responsibilities; statuses of pending tasks; changes to scope, time, and budget; and a forum for the exchange of updated information. Good internal communication will promote efficiency and reduce duplication; ensure timely notifications of changes to scope, time, and budget; confirm adherence to deadlines; and support accurate reporting to the client. Internal communication methods include scheduled team meetings; daily time entries to achieve real-time budget updates; blog postings; and access to an updated team calendar (Budget and Schedule) through the LPM webpage.

For external communications, the Stakeholder/Contacts should be consulted to determine which external stakeholders and client representatives should receive updated information and reports. External communication methods may include client meetings, client access to the LPM system, written status reports, notifications regarding proposed changes to the budget and schedule, and the Change Control Process (described below).

Based on this information, the Communications Plan should identify the following information:

Client Accessible Information. This may include the Project Plan, matter status, milestones and deadlines, budget status, documents (final transactional), documents (litigation filings), documents (client memos), team calendar, team blog and/or team discussion.

Responsibility for Communications. This includes which LPM Team members will be primarily responsible for communications to team members, external stakeholders and the client.

Client Reports—Content and Requirements. This includes what information should be provided at specified times, what should be included in status reports to the client, and what are the methods or technologies used to convey the information (such as email, blog postings, formal reports, web meetings, video conferences and/or Case Notes). It also includes how changes to scope, budget and schedule will be communicated and approved by the client.

Client Reports—Recipients. This includes who should receive information (i.e., not every stakeholder should receive all communications).

Client Reports—Frequency. How frequently updates and status reports should be provided to the client.

Client Requirements—Billing. This ensures that billings conform to the timing and format required by the client. This may be obtained from the Engagement Letter or any other billing guidelines provided by the client.

Other Client Requirements. This may include who must approve changes to the Project Plan documents or changes to the original scope and budget. This may be obtained from the Engagement Letter or any other guidelines provided by the client.

Internal Communications—This includes the frequency and content (agenda) of LPM Team meetings. This should identify what the guidelines are for meetings, such as whether the meetings are formal or informal, who should participate in the meetings, whether the meetings are based upon a predefined agenda, whether minutes will be generated and distributed, identification of action items, and the preparation of an issue log.

Internal Communications—Time Entry and Case Notes Requirements. this includes the requirements for time entry, updating the status of tasks and related Case Notes, as well as the process for notifying the responsible attorney prior to exceeding budget constraints.

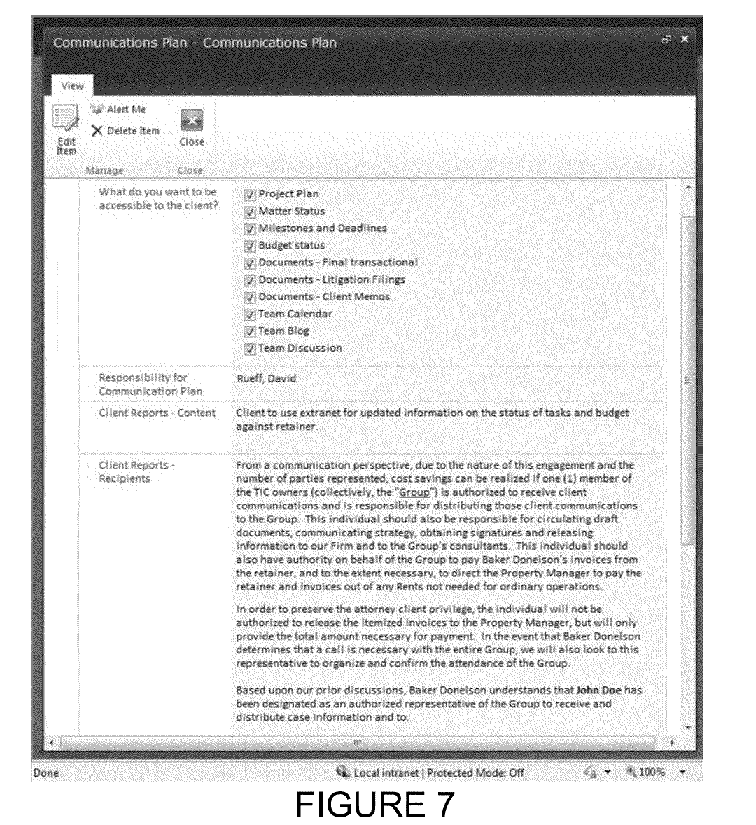

The LPM webpage interface provides a form for the entry and modification of a communications plan in the Communications Plan tab which can be selected as shown in FIG. 7. The plan should be developed with the client and may be accessible by the entire LPM Team through this tab.

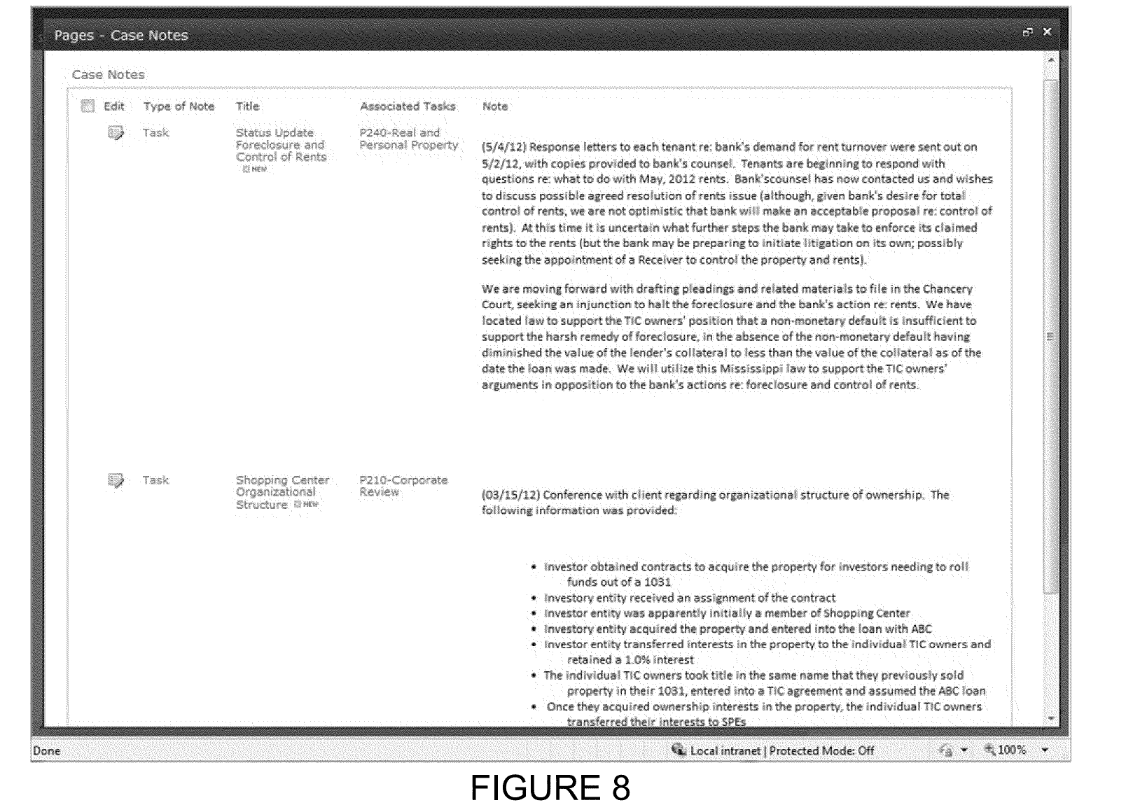

As shown in FIG. 8, a Case Notes tab is accessible through the LPM webpage interface. Although Case Notes is primarily used during the Project Execution Phase as part of the Change Control Process (see below), it also provides real-time summary updates in lieu of e-mail searches and review. It allows team members to summarize updates, and to avoid duplication of work which can result from starts and stops in the engagement. The entries can be general in nature or associated with a specific task. The Case Notes tab is available to the entire team and serves as a method of communicating to the team and/or the client any changes to the project scope, tasks, schedule and budget.

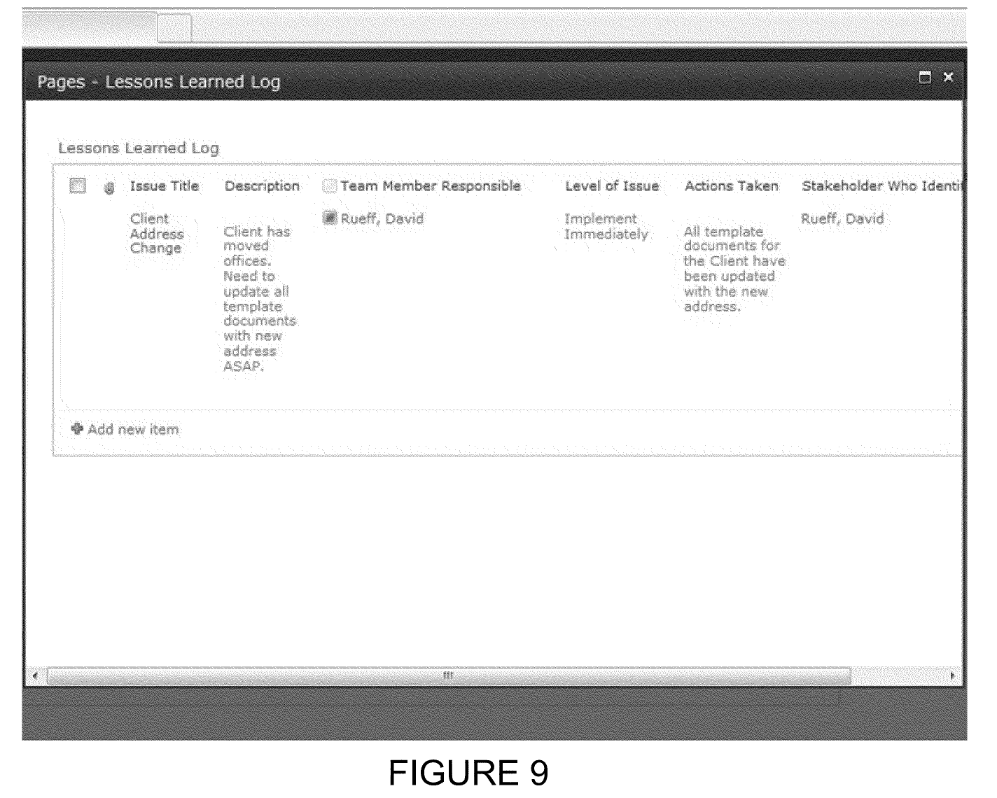

The Lessons Learned Log is accessible through the Project Closure menu, as shown in FIG. 9. Although identifying lessons learned is a part of the Project Closure Phase, it is important to maintain a log during the life cycle of the matter to identify all issues that arise and the solutions for those issues. This is especially important for matters that may span months or years. The log will help facilitate a more complete and thorough review at the completion of the matter. The log is accessible at both the client and individual matter level. For complex litigation matters where a large number of cases are being managed for a single client, the Lessons Learned Log is even more valuable so that attorneys across the team can benefit from the experiences of cases that may be managed by other offices within the Firm.

An LPM Team member is designated as responsible for creating and tracking lessons learned through the Lessons Learned Log, which should be accessible by all team members and part of the Project Management Information System (“PMIS”), described below. The Lessons Learned Log should identify weaknesses to correct for future matters, opportunities to be pursued (whether technical, managerial, policy, procedure, process, or best practices), and changes to forms, databases, templates, task list, schedule, or budget templates.

In one embodiment, the Lessons Learned Log comprises a description of the lesson learned and decision implementation. The log provides a high-level description of the correction or proposed improvement, the team member or stakeholder who identified the issue, and the date submitted. The log may also state whether the issue can wait until the Project Closure Phase for implementation or whether matter resources should be updated immediately. The log further may identify the team member responsible for implementing the lesson learned and the date of implementation. This will include any necessary changes to forms, database design, task list, and schedule or budget templates.

The LPM Team generates the Task List after the initial client meeting. The Task List breaks down the engagement into specific phases, tasks and subtasks within the scope defined by the Statement of Work. These subdivided tasks may be developed from task list templates, checklists, or lessons learned from previous matters. The Task List should also include phases, tasks and subtasks related to the management of the matter in accordance with the Project Execution Phase.

There are numerous approaches to budgeting, however, the two most commonly used methods for legal estimating are “top-down” and “bottom-up” analysis or estimating.

Top-Down Estimating typically is used in conjunction with lower cost engagements or where there is information regarding the cost of like matters. It takes very high level phases and places a dollar value on the estimate of the work to be performed in that phase. The estimate for that phase is then spread across the tasks or subtasks to complete the work.

Bottom-Up Estimating is considered more reliable and is encouraged where the engagement is more complex or where there is a higher cost. It starts at the very lowest level of the work (i.e. tasks or subtasks) and estimates the resource needed to complete the work and the estimate of time to complete the work to derive an estimated budget at a lower level. All task/subtask estimates are then added together to derive an overall estimate for the phase.

The task lists developed at this stage can be used for at least two purposes. First, they may be used to assign tasks to individual team members as discussed below in the Schedule. Second, once the task list is tied to a matter plan in the Firm's financial system, the tasks can be used to track the time entry and fees associated with individual tasks and can be used for standardized time entry descriptions. However, the level of task assignment to team members does not have to match up with the level of tasks which are tracked for budget purposes. For example, task assignment may be to the phase/task/subtask, while budget may only be tracked to the phase/task level.

Regardless of the matter plan selected or newly developed, the Task List can be tied to a Task Based Billing Code System (“Billing Codes”) in the financial system. In one embodiment the Billing Codes are based upon the ABA Uniform Task Based Management System and are very high level and generalized. In this embodiment, the financial system may provide only two levels of categories for tracking tasks and time: a Phase code and a Task code. If the Project Manager or responsible attorney desires to track time entries and budget at a more detailed level, the ABA “Phase” code can be dropped, and the budget can be tracked at a task/subtask level.

In addition to tasks, any risks or uncertain events or conditions that could have a positive or negative effect on the outcome were identified in the Statement of Work and should be detailed at this phase. By identifying the potential risks, the client and the LPM Team can work to increase the probability of positive events and decrease the probability of negative events. If possible, the impact of the risk should be characterized in terms of a numeric variable (e.g., impact on schedule, time required, resources needed). This will allow the impact of the risk to be estimated with regard to schedule and budget later in the LPM system.

The following is a summary of the information that should be collected for this phase for one embodiment:

a. Phase Codes. Generally based on standard template for major types of engagements, such as litigation, business transactions, and the like.

b. Primary Tasks. Work components under each primary task that are unique to the specific matter and that may be assigned to an LPM Team member.

c. Subtasks. Additional level of task list development that can be used for assignment of tasks to team members on the Assignment of Tasks tab and which can be used for more detailed budget development on the Budget tab.

d. Risk. Positive or negative, description of the characteristics of the risk, and the potential impact in terms of a numeric variable.

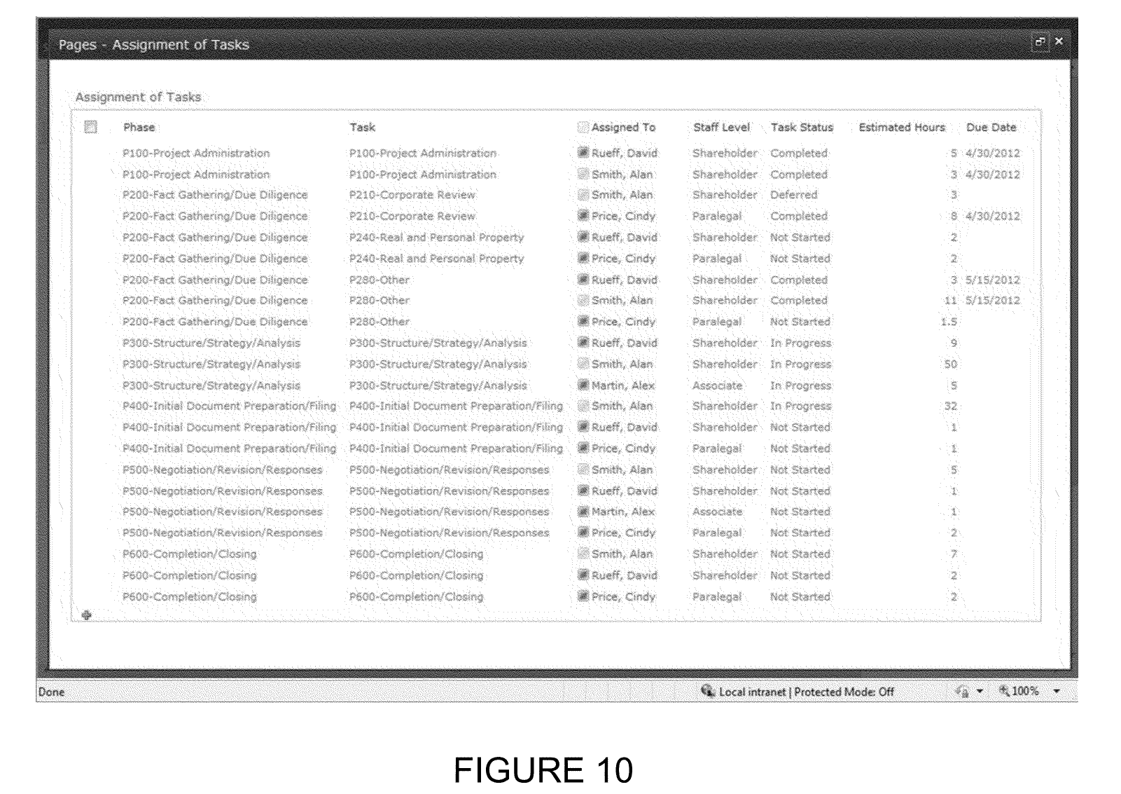

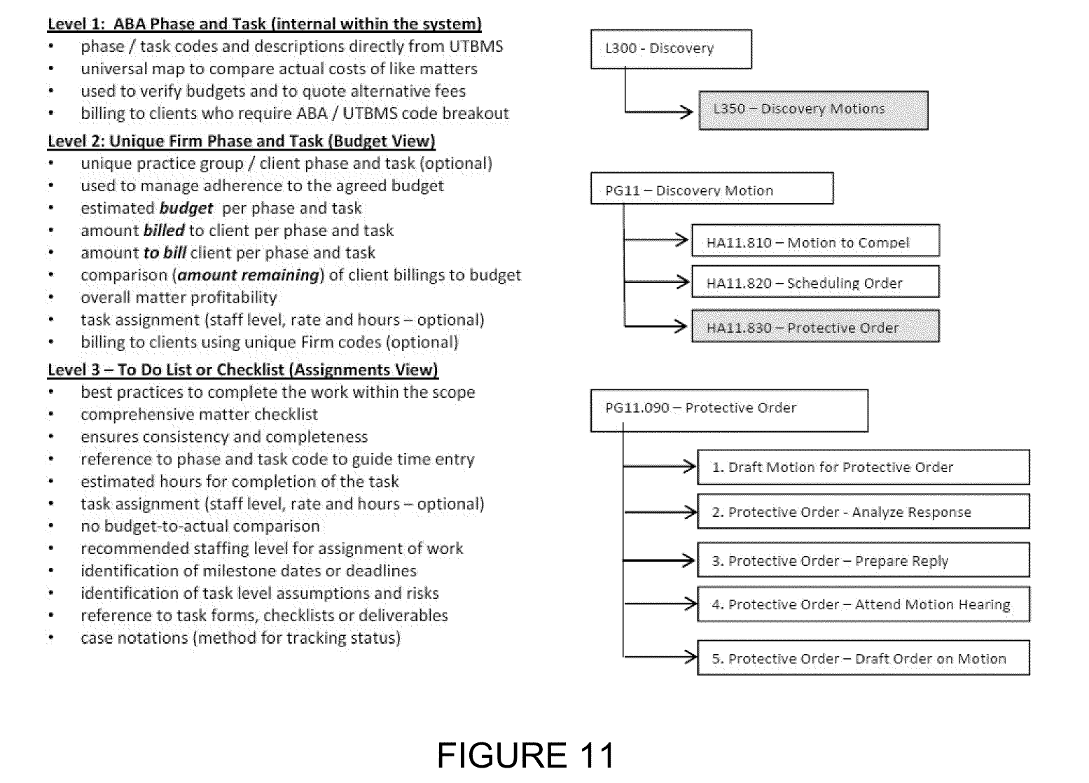

The LPM Assignment of Tasks tab is shown in FIG. 10, and can be used to import template phase and task lists and tailor them for the specific matter. Practice Groups in a Firm, or the equivalent, may develop Task Lists for standard matters. In addition to the development of the phases and tasks, the templates should also include standard assumptions, risks, budgeted time for each tasks and the metrics that the Practice Group desires to track for evaluation purposes. FIG. 11 shows an exemplary embodiment with three levels of phase/task codes.

Scheduling control is an important area for legal matter management. Attorneys and staff members typically manage time by dealing only with pressing issues. If the issue is not urgent, it might be allowed to stagnate until the client or responsible attorney begins asking questions. The goal of the Schedule is to identify for all LPM Team members the required delivery dates for each task to avoid delays and forgotten assignments. Thus, the development of the Schedule necessarily includes the management of human resources.

The Schedule, using the Task List, identifies, for each task and subtask, the assigned team member(s), their respective roles with respect to each task and subtask, and the task or subtask due date. The Schedule may also include time constraints, such as court filing deadlines, contract timeline requirements, and reporting requirements with clients and third parties stakeholders. In one embodiment, the following information is collected in the Schedule:

a. List of Phases/Tasks and Billing Codes. From the Task List.

b. Subtasks. From the Task List.

c. Team Member Assigned. To each Task and Subtask.

d. Staff Level of Team Member Assigned. To Each Task and Subtask.

e. Task Status. Each team member should be responsible for timely updating the status of their assigned task (Not Started, In Progress, Completed, Deferred and Waiting on Someone Else).

f. Estimated Hours. For Each Task and Subtask from the Task List.

g. Due Dates. Deadline for completion of each Task and Subtask.

The system includes the ability to monitor task status (i.e., deferred, not started, in progress or completed), due dates and recommended hours for completion. Additionally, tasks can be synced to and managed from Outlook or other calendar program or application.

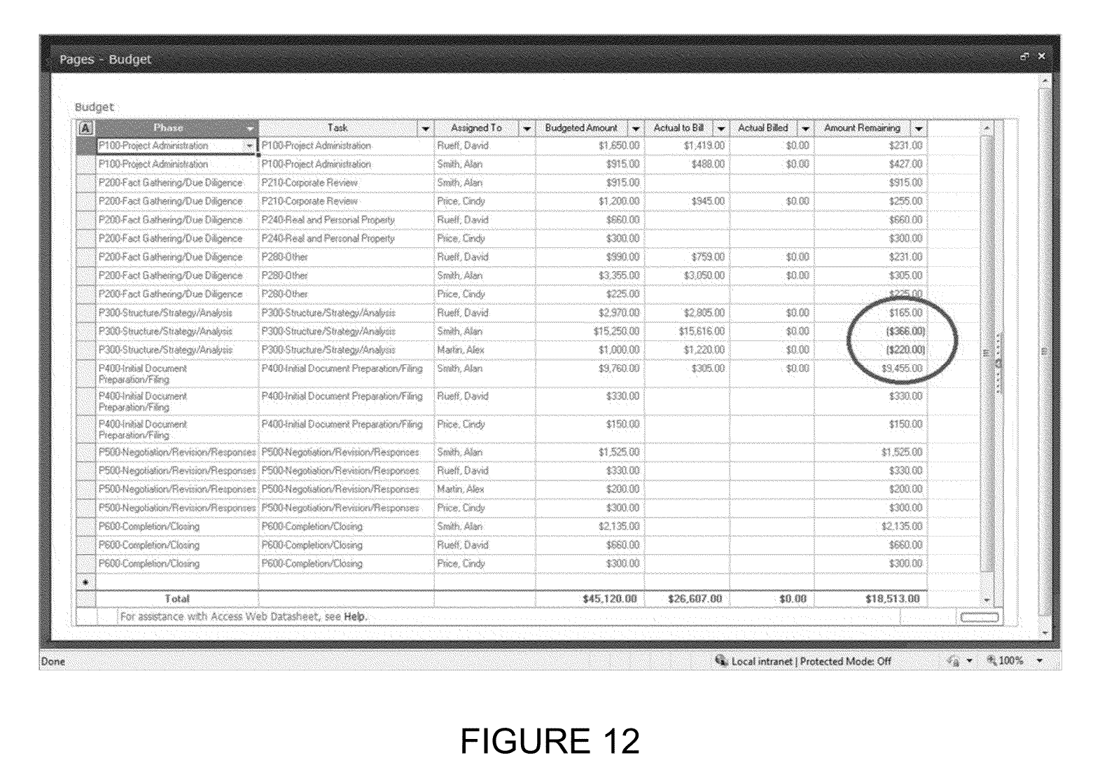

FIG. 12 shows the Budget tab in the LPM interface, which can be filtered by Phases and Tasks. Developing a Budget requires the evaluation of the elaborated phases, tasks and subtasks developed in the Task List and detailed in the Schedule, the hourly cost and/or billing rates of the LPM Team members performing those phases, tasks and subtasks, and the estimated time for their completion. The LPM system provides a simple budgeting tool which allows budgets to be developed based upon the estimated time to complete a task and the rate of the timekeeper assigned to the task. If the matter is an AFA or based upon the size and resource requirements of the matter, the Budget Manager software tool may be used to develop the Budget.

Once the phases, tasks, subtasks, and assigned team members are determined in the Schedule, the key input into the Budget is the amount of time required to complete each task and subtask. Where the matter is similar to matters previously handled by the Firm, templates may be available as a starting point for the time required for each task. The responsible attorney should determine what resources are available to aid in this process. The LPMO, if present, can assist the responsible attorney in this regard.

Over time, budget templates may be developed within each practice area as part of the budgeting process. Budget templates may be created by taking an average of the time required for each task in a worst-case and best-case scenario in similar matters. This creates a baseline for the type of matter to be undertaken. If historical information or a budget template is not available, the responsible attorney will have to draw on their own experience or the experience of other attorneys in the Firm as to the amount of time required for each task or subtask in a baseline case. Once a baseline is created, the responsible attorney must identify variables that may increase, decrease, or have no impact on the time required to perform particular tasks or subtasks. These variables can be derived from risks identified in the Task List and Schedule processes. These variables can be used to develop a worst-case and a best-case template.

The templates will allow the responsible attorney to generate “what if” scenarios to obtain a realistic estimate of the fees and costs of the matter. If the responsible attorney has more definitive information regarding the time required for particular tasks and subtasks involved in the matter, the Budget tab allows the attorney to manually adjust specific figures. After an estimated Budget has been created, the LPM system can also be used to generate reports to compare actual costs to planned costs. Throughout the life cycle of the matter, the reports allow the responsible attorney and the client to make continuing adjustments to the Budget based upon new information.

In one embodiment, the following information is collected for purposes of preparing the Budget:

a. List of Phases and Tasks. The Phases and Tasks are taken directly from the Schedule, but may not include the same level of detail.

b. Team Members Responsible for the Phases and Tasks. From the Schedule; this will include their hourly rate and/or cost as provided in the Statement of Work.

c. Time Required For Each Phase and Task. Estimated time to complete the identified Tasks and Subtasks (in units of time) as provided in the Schedule.

d. Risk Variables. The risks as provided in the Schedule that could increase or decrease the estimated time required and an assigned unit of time value for each such risk.

Once the information has been entered into the Budget tab, the system automatically generates a total of the projected fees. As discussed in more detail in the Project Execution Phase, once the matter is underway, the LPM system also interfaces with the Firm's financial systems to display actual fees on the matter. This information is updated every hour. The Budget tab can then be used to compare the actual time entries to the projected entries for Phases and Tasks, as seen.

As a final step in this phase, and prior to starting the majority of the work with the client in the Project Execution Phase, a short meeting should be conducted with the client to review the LPM site for the particular project, and the Project Plan information. Additionally, a short meeting should be conducted with the entire LPM Team to review the same information and to confirm goals and expectations among team members. Information discussed at these meetings should include: Description of Engagement/Case Background; Stakeholders/Contacts; Statement of Work; Communications Plan; Schedule; and Budget.

After the Project Plan is developed and approved, the LPM Team's time will be spent in the Project Execution Phase. At the outset of the Project Execution Phase, several organizational tasks should be performed (the matter management organization process).

The first task is setting up the Project Management Information System (“PMIS”), which is used for the efficient management of the matter. The PMIS comprises Firm forms, software tools and techniques to gather, integrate, and disseminate outputs of the LPM system. Individual attorneys utilize the best tools at their disposal to manage matters, which may be checklists, calendars, spreadsheets, form libraries and informal meetings and conferences. The PMIS enables the LPM Team to view team calendars for deadlines and availability, to have continuous access to the status of tasks and responsibilities in the Schedule, to monitor the status of the Budget and most importantly, to have a controlled and recorded mechanism for communication among the team members, external stakeholders and the client.

Initially, the PMIS comprises on-line forms for the Matter Description, Statement of Work and Communications Plan completed by the responsible attorney as part of the LPM workflow. The matter record should also include the matter engagement letter and terms of engagement. These documents should be continually updated to incorporate changes resulting from new information or approved deviations from the original Project Plan. The LPM system is used to manage this information and to share it internally with team members and externally with external stakeholders and the client. The PMIS should not only incorporate the Project Plan information and other LPM Process documentation, but also allow the LPM Team to integrate tasks, budgets, and schedules so that modifications to one component will simultaneously identify the impact on other components.

The second task is confirming legal resources. During the initial client meeting and the preparation of the Stakeholders/Contacts, the LPM Team members and their roles were generally identified based on information known at that time. In the Project Plan, the positions and rates were further elaborated to identify the necessary legal staff. The Task List broke the client requirements into tasks and subtasks for each team member and external stakeholder. This information was then plugged into the Schedule and Budget as part of the Project Plan.

At the beginning of the Project Execution Phase, the responsible attorney should meet with the LPM Team members and external stakeholders to confirm their engagement and communicate responsibilities. Proper communication of responsibilities will avoid duplication of work and ensure everyone's understanding of tasks, schedule, and budget constraints.

The third task is engaging third party resources. The Project Plan also identified any necessary third party resources. This includes both internal resources and external resources. The responsible attorney must also engage these resources to insure that any non-legal tasks are completed within the Budget and Schedule. This may also involve the negotiation of third party agreements.

The fourth task is implementing communications. The Project Plan includes a Communications Plan developed with the LPM Team, external stakeholders, and the client. A team member was assigned the primary responsibility for implementation of the plan, which includes scheduling reporting, status meetings, and confirming all team members understanding of communication and record keeping responsibilities. Additional assignments may also be made to team members for taking minutes of meetings, distributing action items, maintaining logs (see Lessons Learned and Change Requests/Case Notes below), updating the Project Plan, and updating the PMIS.

A key benefit of the LPM system is a predictable fee and a timely and efficient resolution of the matter. The Project Development Phase identifies the client's expectations and goals, matter scope, matter requirements (including tasks and subtasks), Schedule, Budget and Project Communications. These elements define the baseline against which performance is measured. These benefits of LPM are achieved if the responsible attorney (or another team member) continually monitors actual performance against this baseline and communicates this information to the LPM Team, the client, and external stakeholders.

The following general matter areas should be closely monitored by the responsible attorney (or other person) to identify the need for curative actions, take proactive steps to avoid material deviations from the Project Plan, or, if necessary for the successful completion of the matter, ensure that deviations are approved by the client through the change control process discussed below.

Monitor Tasks. The scope of the matter was generally identified in the Statement of Work. The scope was then broken down to identify individual tasks and subtasks and associated Billing Codes in the Task List. These tasks and subtasks were also given estimates for time and budgets in the Project Plan. As the matter progresses, the LPM Team members should regularly update the PMIS to provide the responsible attorney with current information on the status of tasks and subtasks, particularly when new issues arise that require additional tasks or when team members anticipate a deviation from planned tasks.

Monitor Schedule. The Schedule identifies delivery dates for various tasks and subtasks. Team members should each be responsible for managing their tasks within the schedule and regularly updating the Schedule with the status of their assignments. Additionally, the responsible attorney must be prepared to address internal constraints such as resource availability or unforeseen external constraints such as third party delays or tactics by opposing counsel. Although these constraints may be unpredictable, by closely monitoring the Schedule, their impacts can be limited.

The tasks and subtasks and their delivery dates may be uploaded into a calendar software tool to assist with the management of the Schedule as seen in FIG. 12. The Team Calendar will enable events to be calendared and viewed by the entire team, and notifications or reminders to be provided to team members and external stakeholders. Additionally, the Team Calendar can be synced to and managed from Outlook or other calendaring program or application.

Monitor Budget. Typically, budgets are managed monthly during billing. Where the status of matter billings is reviewed only once a month, there is a higher risk of substantial deviations from the expected fees. These deviations may be caused by inefficient team members, duplication of effort, performance of tasks that are out of scope without client approval, or the failure to communicate client changes to the remainder of the team. These deviations can result in dissatisfied clients or write offs.

Under the LPM process, the Budget Manager tool can be used to track Budget status. For Budget Manager to provide accurate information on the status of the budget, team members must commit to update their time entries daily using approved Billing Codes; and the responsible attorney must commit to regularly comparing actual performance to the Budget. Drawing upon information in the Firm financial management system, reports can be generated to provide real-time information on the Budget. By using the Billing Codes, the responsible attorney can identify areas that are at risk for exceeding the Budget. This will also enable the LPM Team to accurately communicate forecasts and status reports to the client and to timely communicate anticipated changes in the budget to the client before significant deviations. Proper real-time budget evaluation tools can also streamline the budgeting oversight process and provide historical information for more reliable estimates.

Monitor Project Resources. The management of tasks, schedule, and budget will necessarily involve management of resources. The key to monitoring team resources is communication. The Communications Plan should provide for regular communications throughout the life cycle of the matter among LPM Team members, the client, and external stakeholders. The PMIS will aid this process by making information available on a real-time basis. Additionally, the precise identification of tasks and responsibilities will help team members understand expectations.

Monitoring resources also includes oversight of LPM processes and procedures, such as adherence to the Communications Plan, confirming approval of changes to the Project Plan, and updating the Lessons Learned Log (described below) and the Change Requests/Case Notes (described below). The responsible attorney can conduct regular performance reviews or team meetings to address questions and concerns of team members.

In one embodiment, the LPM Team can access a tool through the LPM interface to assist with management of tasks, schedule and budget under the My Tasks tab. This tab is set up to display pending tasks, budget constraints and due dates. When the team member logs into and accesses the LPM system, the My Tasks tab displays this user specific information. Additionally, tasks can be synced to and managed from Outlook or other calendaring program or application.

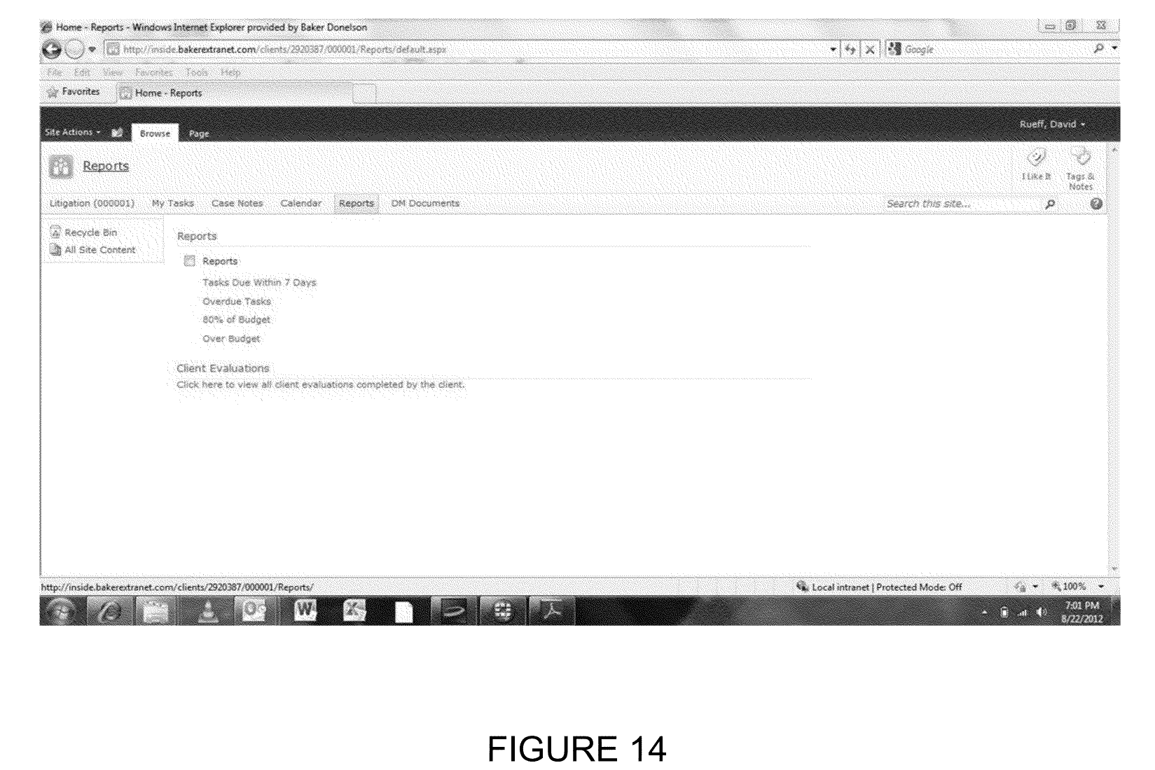

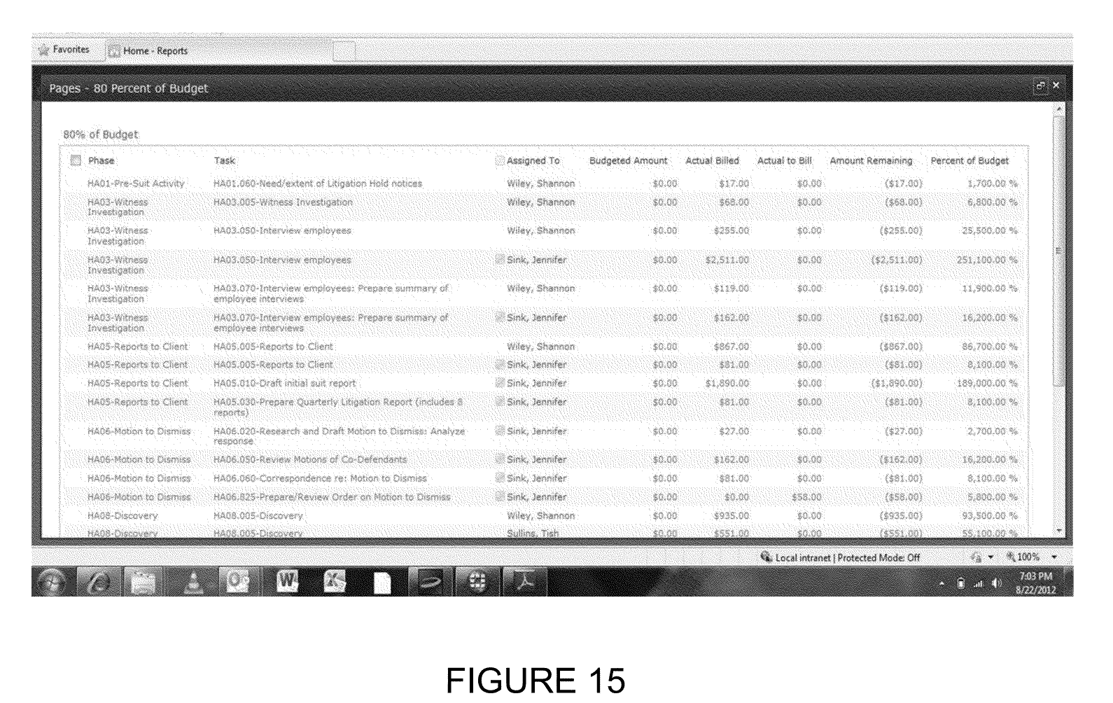

The responsible attorney or project manager also may review the overall matter through the Reports tab, as seen in FIGS. 14 and 15. The Reports tab is set up to display upcoming tasks that are due and/or overdue, and tasks that are within a certain percentage (e.g., 80%) of budget and/or over budget. The Reports tab also provides a link to any Client Evaluations completed by the client throughout the life cycle of matter.

Based upon the information assembled in the monitor performance process using the PMIS, team meetings, and other tools, the responsible attorney can consistently manage matter performance. This will enable the responsible attorney to identify and communicate necessary corrective actions to the team and to communicate to the client any deviations from scope, schedule, and budget; the need for additional resources; and necessary modifications to the Project Plan.

If no corrective action is required based upon the information available, a periodic status report may be provided to the client based upon the requirements identified in the Communications Plan. The content of the status report is outlined below.

If the information generated during the monitor performance process identifies necessary corrective actions or changes, the responsible attorney should immediately meet with team members to discuss deviations from scope, schedule, or budget and to identify the reasons for the deviations and corrective actions. Once these corrective actions are identified, the responsible attorney must determine whether the deviations are material and whether they should be communicated to the client. If a necessary change is material, the responsible attorney should implement the change control process to confirm the impact of the change, provide a status report to the client detailing the required changes, and, where required, obtain the necessary approval from the client.

Regular reporting to the client is an important component of the LPM process. Status reports provide the client with a high-level status of the Project Plan and adherence to the Budget and Schedule. The status report should include quantifiable measures of progress and confirm conformance with the Project Plan. The status report should be distributed to all parties based upon the Communications Plan. Although the regularity of the status report will be controlled by the Communications Plan, the team should consider providing reports contemporaneously or in conjunction with client billings. The reporting process may also include a mechanism for acceptance by the client or a follow up meeting to address any client issues or concerns.

In one exemplary embodiment, the following information is included in the status report:

General Matter Information. The report should include the matter name, matter number, preparer, and contact information.

Status Information. The report should identify the status of the Budget, Schedule, and Project Communications.

Changes from Last Report. The report should identify any changes since the last status report (including date submitted, date resolved, or pending), including changes to risks, assumptions, Schedule, or Budget.

Selected Metrics. Identification of any other quantifiable metrics that help communicate the performance of the team (such as the number of completed due diligence items, documents drafted for a transaction, or the status of discovery, motions, or trial preparation in litigation).

Changes that are needed as the project progresses are handled by the Change Control Process. During the Project Development Phase, the team attempts to generally identify risks in the Statement of Work and provide more detailed information regarding the impact of those risks in the Task List. Risks are identifiable, but uncertain events or conditions that may affect the matter objective. Examples of risks include anticipated new regulations, known problems that could arise in the due diligence process, the potential addition of new parties to litigation, and the like. Unlike risks, “changes” are unplanned events, concerns, or problems that impact the matter scope, Schedule, and Budget. They may also have a significant impact on previously approved processes and procedures. Both risk and change resolution should be managed through the Change Control Process.

Continuous analysis of actual performance will help identify risks and changes. Responsive actions may include preventive measures or corrective action. A cooperative process should be implemented between key members of the LPM Team, external stakeholders, and the client decision-makers to confirm the appropriate responses. Because not all changes will be material, the process should clearly identify those responses that can be made without formal approval and those that will require evaluation through the change control process.

When a risk or necessary change is identified, the LPM Team should meet to define the issue, determine why a response is necessary, assess the materiality, assign a priority ranking (i.e., emergency, urgent, high, medium, or low), and decided on the team's recommended response. Once this information is assembled, the team should determine whether the issue is material and whether a response requires approval by the client.

If changes to the Project Plan must be approved by the client (or changes to the negotiated fee are required under an AFA), the Change Control Process should identify not only what types of issues must go through the approval process, but also the format of the request submission and the client's documentation requirements, what client representative is authorized to approve the change request, and how the external stakeholders will be notified of an approved request.

After the client meeting to review a proposed change in the Project Plan, the decision of the meeting should be documented. As a matter progresses, the reasons for decisions may be forgotten, which can result in reversals or new decisions for the same problem. Clients may also make decisions that go against the advice of the LPM Team. These decisions may be based upon client business concerns or external factors beyond the control or knowledge of the team. A Change Request in the Case Notes should be maintained to document the change issues and decisions. The information maintained in the Case Notes should include a high-level description of the risk or proposed change, the impact of the proposed change on the Project Plan, and the team's recommendation along with the client's decision. Based on the outcome of the client's decision, the team member responsible for implementing it should also be identified.

The Case Notes tab, as seen in FIG. 8, and discussed above is used to record this information. The Case Notes tab is accessible from both the top bar and in the Project Execution menu. The Case Notes tab is available to the entire team and serves as a method of communicating to the team and/or the client any changes to the project scope, tasks, schedule and budget.

Although part of the Communications Plan, identifying additional lessons learned and implementing them is a part of the Project Closure Phase. The LPM system provides a tool to record information for lessons learned. As discussed above, the Lessons Learned Log is accessible from the Project Closure menu as shown below in FIG. 8. The log is accessible at both the client and individual matter level. For complex litigation matters where a large number of cases are being managed for a single client, the Lessons Learned Log is even more valuable so that attorneys across the team can benefit from the experiences of cases that may be managed by other Firm offices.

Once a matter is completed, the Project Closure Phase begins. Typically, once a matter is completed, formal file closure involves confirming that all outstanding amounts have been paid by the client, updating the hard copy matter file with pleadings, correspondence, or final documentation, and formally closing the file in the Firm's system for purposes of conflicts. The LPM system goes beyond these steps to capitalize on the LPM Team's experience. This phase includes a series of follow-up meetings with both the client and team to identify improvements to the Firm's knowledgebase.

Upon completion of the matter, a meeting should be conducted with the client to identify improvements to future matters. This meeting will foster repeat business with the client by demonstrating an interest in a continued and improved relationship. Before this meeting, the LPM Team should review the Lessons Learned Log and the Change Requests/Case Notes to identify any client-specific improvements appropriate for discussion with the client. Client-specific improvements may involve the Project Plan (i.e., scope, schedule, budget, or communications), negotiation or litigation tactics, or changes to forms, checklists, or templates used for that specific client. Upon completion of the meeting, the Lessons Learned Log should be updated to include the information indicated above.

At the client meeting, the client should receive either a form or an extranet link for the completion of an evaluation. The evaluation form should address overall performance of the matter, additional recommendations for improvements, and specific observations regarding members of the team. Once the form has been completed, the client attorney or responsible attorney should review the information to identify any additional lessons learned or recommendations for improvement.

After the client meeting and completion of the client evaluation, the LPM Team should meet to confirm that all LPM system documentation is updated, to discuss the client evaluation, and to identify lessons learned. By reviewing LPM documentation, the team will confirm that all lessons learned have been identified. In one embodiment, the documentation comprises the following: Engagement Letter or AFA Agreement; Terms of Engagement; Stakeholder/Contacts; Statement of Work; Communications Plan; Task List; Schedule; Budget; Project Setup and Monitoring Checklist; Report Format; Change Log Format; Lessons Learned Log Format; and Client Evaluation Form.

Upon conclusion of the LPM Team meeting, the Lessons Learned Log improvements should be made in a timely manner to the Firm's knowledgebase (e.g., forms, checklists, and templates for task lists, budget, and schedule) by the team members identified in the log. A date for completion should be identified in the log.

In addition to project-specific meetings, each practice group (or equivalent) in the Firm can conduct periodic meetings to compare the lessons learned and identify further improvements to practice group resources. Once this information is updated, the lessons learned become a source of historical information for use by all Firm personnel.

Formal file closure requires updating all LPM documentation identified above, identifying the file as closed in the conflicts database, and confirming that the PMIS and soft copy documentation for the matter is archived. A team member may be responsible for working with the Firm's IT Department to confirm that the PMIS is archived. In addition, once a matter is completed, the responsible attorney should confirm file closure in Firm's matter management system. If a matter is not designated as “closed,” the system will not identify the status of potential conflicts. If the matter continues to be listed as open, it will require correspondence between attorneys to confirm the status of the matter and will result in wasted time for attorneys opening new matters.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A computer-implemented method for legal project management, comprising the steps of:
obtaining information about a project;
developing, using a processor or microprocessor, a statement of work;
developing, using a processor or microprocessor, a project task list;
developing, using a processor or microprocessor, a project management plan;
obtaining approval for the project management plan; and
monitoring on a daily basis, using a processor or microprocessor, while executing the project management plan, the status of tasks completed, compliance with the schedule, compliance with the budget, and use of resources.

2. The method of claim 1, wherein the project management plan comprises a schedule, a budget, and a communications plan.

3. The method of claim 1, further comprising the steps:
determining whether corrective action is or is not required; and
if corrective action is require, implementing a change control process.

4. The method of claim 1, further wherein all individuals executing the project management plan enter, using a processor or microprocessor, time spent and expenses for the project on a daily basis.

5. The method of claim 4, further comprising the step of automatically, using a processor or microprocessor, providing an alert to a project manager when project costs exceed a predetermined threshold value.

6. The method of claim 1, further comprising the steps of:
completing the project; and
evaluating the extent of compliance with the project management plan.
